(19) United States
(12) Patent Application Publication
(10) Pub. No.: US 2009/0104097 A1
(43) Pub. Date: Apr. 23, 2009

(54) MERCURY REMOVAL FROM A GAS STREAM

(75) Inventor: James B. Dunson, JR., Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington, DE (US)

(21) Appl. No.: 12/253,371

(22) Filed: Oct. 17, 2008

Related U.S. Application Data
(60) Provisional application No. 60/999,346, filed on Oct. 17, 2007.

(51) Int. Cl. B01D 53/64; C04B 14/00

(52) U.S. Cl. 423/215.5; 252/182.33; 106/640

(57) ABSTRACT

This invention is a novel process for removing volatile mercury from a gas stream to produce a filtered solid. The gas stream is contacted with treating agents which comprise a semivolatile acidic vitrifying compound such as boric acid, water, oxygen-containing gas and a chlorine source. The filtered solids produced in the process have low mercury leachability thereby allowing the solids to be used, for example in flyash-containing concrete.

### FIELD OF THE INVENTION

The present invention relates to a process for the removal of volatile mercury from a gas stream and to the resulting filterable solid.

### BACKGROUND OF THE INVENTION

Heavy metals are one of the most problematic pollutants known. These heavy metals include arsenic, beryllium, lead, cadmium, chromium, nickel, zinc, mercury and barium. Mercury, in particular, has become a target for increased regulations due to its high volatility and lack of reactivity in pollutant control systems. Mercury, as well as other heavy metals, can be found naturally in numerous combustion fuels such as coal, oil, natural gases, biomass and wastes.

When heated to combustion temperatures, mercury volatilizes and these volatile forms of mercury in flue gas stream pass through most scavenging systems and are emitted into the atmosphere. Once heat-volatilized mercury is emitted into the atmosphere, it can transform into other, more toxic forms. Mercury vapor can photochemically oxidize into an inorganic form and collect in water systems during rain fall. Bacteria in water systems transform inorganic forms of mercury into organic mercury, such as methyl mercury, which can bio accumulate in vegetation and fish. The mercury contaminated vegetation and fish may then be consumed by animals and humans.

Current processes for mercury removal include dry scrubbing systems and wet scrubber systems. Dry scrubbing systems utilize special activated carbon or lime coated carbon to absorb mercury. Wet scrubber systems are designed to capture sulfur dioxide and remove mercury by converting volatile metal chloride to a non-volatile form which is captured.

At temperatures from about 250° C. to 350° C., special activated carbon powder converts mercury vapor to a non-volatile form which allows mercury to be removed from a gas stream prior to emission. Metal oxides in the special activated carbon, in the presence of hydrogen chloride (HCl) gas and oxygen (O₂) catalyze the Deacon process and convert mercury metal (Hg) to mercuric chloride (HgCl₂). Mercuric chloride further reacts with excess carbon, and is reduced to mercurous chloride (Hg₂Cl₂), a low volatility compound which can be filtered from a flue gas stream. An excess of volatile organic compounds may over-reduce Hg₂Cl₂ to elemental mercury. Also, excess Deacon chlorine can react with volatile organic compounds adsorbed on carbon to form chlorinated dioxins. This by-product of activated carbon use is chemically hazardous. Furthermore, powdered carbon dust from use of activated carbon is potentially explosive, and the presence of powdered carbon limits the normal use of coal flyash in lightweight concrete.

Sulfuric acid is known to poison the Deacon reaction, so activated carbon coated with lime is often used where sulfuric acid is present in an exhaust gas. The lime keeps the sulfuric acid away from the metal oxides in the carbon allowing for Deacon reaction. Two examples of lime-coated special activated carbons are SORBALIT, available from Lhoist Group, Limelette, Belgium and DESOMIX, available from Donau Carbon GmbH & Co. KG, Frankfurt, Germany. Lime itself when almost damp can adsorb mercuric chloride (below 120° C. and within 10° C. of the dew point of water), which may allow sulfuric acid corrosion of treatment system ductwork.

Wet scrubber systems designed to collect sulfur dioxide (SO₂) convert the HgCl₂ to Hg₂Cl₂, a fine precipitate, which can be filtered and removed. Two drawbacks of the wet scrubber systems are that too little SO₂ can result in unreacted HgCl₂, while too much SO₂ can result in an over reduction of the HgCl₂ to Hg, along with generating a custard-like “mousse” of calcium sulfite, instead of the much desired fine crystal gypsum precipitate which is easily filterable.

For dust collection, economical electrostatic precipitators are currently used for high sulfur coal combustion due to the ash being glassy, with few fines. Switching to a low sulfur coal, the ash usually will be powdery, with high fines content, requiring expensive dust collection equipment, unless the ash is high oxide factor. Dunson, J. B., disclosed a threshold “oxide factor” in “Effects of Ash Chemistry on Electrostatic Precipitator Performance” presented at Air Pollution Control Assoc., 74th Meeting, Philadelphia, Pa., June 1981 The oxide factor is the weight ratio of the flux (iron oxide, sodium oxide, and calcium oxide combined) to the weight percent of alumina, where a ratio greater than 0.4 is associated with the formation of glassy ash which is inexpensive to collect in electrostatic precipitate collectors. Low sulfur coals with less than 0.4 oxide factor typically produce powdery ash. For low sulfur coal ash, an agglomerating agent may be needed to avoid powdery ash.

Brasseur, A., et al., in Chemosphere 56 (2004) 745-756, disclose possible inorganic substitutes for carbon sorbents for the removal of organic pollutants without the auto ignition risks associated with carbon. While some inorganic substitutes removed the pollutants and heavy metals, none of the examples studied matched the effectiveness of the currently used carbons.

Clemens, A. H., et al., in Fuel 79 (2000) 1781-1784, disclose partitioning behavior of boron in the presence of inorganic rich layers in sub-bituminous coal seams. The presence of titanium was shown to have an inverse effect on boron retention. Titanium rich mixtures had a higher boron concentration in the cyclone ash and flue gas, resulting in higher boron emissions, due to competing reactions of titanium and boron adsorptions with calcium aluminosilicate. No mention was made, however, whether either titanium or boron affected the mercury removal of flue gases.

A need exists for an effective process for volatile mercury removal from a gas stream. Such a process needs to produce a filterable product which results in low leachability of mercury and low carbon content in order for it to be useful in applications in lieu of secure land filling.

### SUMMARY OF THE INVENTION

One embodiment of the present invention is a process to remove volatile mercury from a gas stream comprising volatile mercury compounds which comprises contacting the stream with: (a) a vitrifying compound, (b) water, (c) oxygen-containing gas, (d) a chlorine source, and (e) optionally an organic titanium complex or an organic zirconium complex, to provide a filterable stream; and filtering the stream to obtain a solid product comprising mercury.

Another embodiment of this invention is a filterable solid product which has low leachability of mercury, low carbon content and can advantageously be useful as a filler in certain applications instead of disposal in a landfill.

### BRIEF DESCRIPTION OF THE DRAWINGS

FIG. 1 is a flow diagram of a simple burner system for use in the process of this invention.

### DETAILED DESCRIPTION OF THE INVENTION

One embodiment of the present invention is a process to remove volatile mercury from a gas stream comprising volatile mercury compounds which comprises contacting the stream with: (a) a vitrifying compound, (b) water, (c) oxygen-containing gas, (d) a chlorine source, and (e) optionally an organic titanium complex or an organic zirconium complex, to provide a filterable stream; and filtering the stream to obtain a solid product comprising mercury. Collectively, the vitrifying compound, water, oxygen-containing gas, chlorine source and optional organic titanium complex or organic zirconium complex are referred to herein collectively as treating agents.

Another embodiment of this invention is a filterable solid product which has low leachability of mercury, low carbon content, and can be useful in combination with Portland cement to make high-strength or lightweight flyash concrete instead of disposal in a landfill.

### Volatile Mercury

Mercury is found naturally in many fossil fuels, such as coal, crude oil and natural gas and in wastes streams such as from hospitals, municipal solid waste, scrap-melting steel mills, and secondary smelter off gases. Combustion of these sources leads the mercury and mercury compounds to volatilize in an exhaust gas stream. Conventional pollutant control systems do not adequately trap the volatile mercury and mercury compounds.

For purposes of this invention, “mercury compounds” or “Hg” will be meant to be any compound or complex that has mercury as one of the elements including elemental mercury. Examples of mercury compounds include mercuric chloride, mercurous chloride, elemental mercury, organomercuric compounds, ionic and oxidized forms of mercury, and mixtures thereof. Concentrations of the mercury compounds by weight relative to fuel can be from 0.1 to 1000 parts per million (ppm).

### Gas Stream

The gas stream comprises volatile mercury compounds and fly ash. The gas stream to be treated can be flue gases generated from the combustion of fossil fuels such as coal, oil, natural gas, or combinations thereof. The gas stream can also be an exhaust gas stream produced during the thermal treatment (such as incineration) of mercurial wastes such as from hospitals, wastewater treatment, municipal solid waste concentrates, scrap-melting steel mill equipment, or secondary metal smelter off gas. Some components which may be in the gas stream include air, SOₓ, NOₓ, organic compounds, heavy metals including mercury, inorganics, particulates and combinations thereof. Other components found in fossil fuels and waste sources that will volatize during combustion or incineration include compounds comprising boron, chlorine, lead, zinc, copper, silver, or mixtures thereof.

The temperature of the gas stream is less than about 250° C. Preferably, the temperature is between about 190 and about 230° C. The pressure of the stream is preferably near, or slightly above, atmospheric pressure, such as from 90 to 200 kPa.

### Vitrifying Compounds

The present invention comprises contacting the gas stream with a vitrifying compound. Vitrifying compounds are semivolatile acidic compounds that are capable of scavenging mercury during glass formation after combustion or thermal treatment. In the present invention, the gas stream is contacted with a vitrifying compound after steam generation, e.g., after treatment in a combustion chamber or after incinerator. Thus, the gas stream is at a temperature, which allows the vitrifying compound to deposit as an active film on the surface of ash to scavenge mercury. Naturally occurring boron, found in some coals, is considered herein to be a vitrifying compound, but only if available for mercury removal. Usually the naturally-occurring boron found in coal is not available for mercury removal at the surface of flyash due to having diffused throughout the mineral matrix at higher temperatures, and thus not useful as a vitrifying compound in this invention. Examples of vitrifying compounds include boric acid, phosphoric acid, methyl borate, or a combination of two or more thereof. Preferably, the vitrifying compound is boric acid. The vitrifying compound is generally used at a concentration of from about 2 to about 12 moles per mole of mercury, preferably from about 3 to about 6 moles per mole mercury.

The vitrifying compound can optionally be and is preferably dissolved in a solvent. Any solvent known to dissolve vitrifying compounds, such as those compounds described above, and does not adversely affect mercury removal can be used. Suitable solvents include but are not limited to water, isopropanol, methanol, butanol, or mixtures thereof. Preferably, the solvent used is isopropanol. The solvent will facilitate introduction of the vitrifying compound into the gas steam by any means known by those in the art including spraying. When dissolved in a solvent, the vitrifying compound is generally present in the solution at a concentration of 5 to 20% by weight of solvent.

### Water

The present invention requires hydrolyzing the mercury treating agents with water. Water can be present from the combustion process of waste or fossil fuels. Water can be unprocessed, or processed, filtered or unfiltered and can come from naturally occurring bodies of water or storage tanks. No special preparation is needed for the water used. It is understood that the water used may comprise minerals and/or salts normally found e.g., in unprocessed, unfiltered, and naturally occurring bodies of water. The water may be injected into the process post-combustion or prior or during the mercury removal process.

Water is typically used in an amount greater than about 2 moles per mole of vitrifying compound, preferably greater than about 6 moles per mole of vitrifying compound.

### Oxygen-Containing Gases

In the present invention, elemental mercury is oxidized to HgCl₂ in the presence of a chlorine source. Oxygen-containing gases include any gas that contains oxygen and is capable of oxidation. Examples of such gases include molecular oxygen (pure oxygen), air, or oxygen-depleted combustion flue gas. The oxygen-containing gas can be found already in the gas stream from the combustion or incinerating process or can be added to the gas stream prior to or during the mercury removal process, that is, the oxygen-containing gas may be a combustion gas stream comprising oxygen.

The oxygen-containing gas may be used in the process to provide a concentration in the range of from about 3 to about 15% oxygen in the oxygen-containing gas. Preferably, the oxygen-containing gas will come from a combustion process, i.e., oxygen-depleted combustion flue gas, and the concentration of oxygen will be below 5% by volume of dry flue gas.

### Chlorine Source

The present invention requires contacting the stream with a chlorine source. The chlorine source can be present in fossil fuels and waste and volatized during combustion or incineration and may also be added separately to the stream. Chlorine sources include any compound capable of generating HCl under combustion or incineration process conditions. Such compounds include sodium chloride, hydrochloric acid, trichloroethylene, dichloromethane, dichlorobenzene, or combinations thereof. During combustion (burning), the chlorine source generates HCl; HCl reacts with oxygen during mercury abatement to form chlorine, which then reacts with mercury to produce mercuric chloride.

The chlorine sources disclosed above can be used in the process so long as they are in substantial excess relative to mercury. The chlorine source is typically added in an amount capable of generating at least 10 moles of HCl per mole of mercury.

### Organic Titanium and Zirconium Complexes

The present invention optionally comprises contacting the gas stream with an organic titanium complex or an organic zirconium complex. Any organic titanium complex or an organic zirconium complex, or a combination thereof, as used herein includes organic titanium compounds and organic zirconium compounds that can remove volatile mercury. Examples of suitable organic titanium complexes and organic zirconium complexes include, but are not limited to those expressed by the formula M(OR)₄ where M is zirconium or titanium and each R is individually selected from an alkyl, cycloalkyl, alkaryl, hydrocarbyl radical comprising from about 1 to about 30 carbon atoms per radical, preferably from about 2 to about 18 carbon atoms per radical, and more preferably about 2 to about 12 carbon atoms per radical and each R can each be independently the same or different. Suitable organic titanium complexes and zirconium complexes may be selected from the group consisting of zirconium acetate, zirconium propionate, zirconium butyrate, zirconium hexanoate, zirconium 2-ethyl hexanoate, zirconium octoate, tetraethyl zirconate, tetra-n-propyl zirconate, tetraisopropyl zirconate, tetrabutyl zirconate, titanium acetate, titanium propionate, titanium butyrate, titanium hexanoate, titanium 2-ethyl hexanoate, titanium octoate, tetraethyl titanate, tetra-n-propyl titanate, tetraisopropyl titanate, tetrabutyl titanate, and combinations of two or more thereof. Preferably, the organic titanium complex or organic zirconium complex is selected from the group consisting of tetraethyl titanate, tetra-n-propyl titanate, tetraisopropyl titanate, tetrabutyl titanate, and combinations of two or more thereof. These organic titanium complexes are commercially available.

Each of the organic titanium complexes or organic zirconium complexes or combinations thereof disclosed above can be used in the process in the range of from about 0.1 to about 1 mole of organic titanium complex or organic zirconium complexes or combination thereof per mole of vitrifying compound. The preferred range is from about 0.3 to about 0.5 mole of the complex per mole of the vitrifying compound.

### Process

In the process of this invention, a gas stream comprising flyash and volatile mercury-containing compounds is contacted with treating agents. The treating agents comprise a vitrifying compound, water, a chlorine source and optionally, an organic titanium complex or an organic zirconium complex. The gas stream may be from a combustion or incineration process. The gas stream, which comprises flyash, e.g., derived from a fuel source such as coal, and mercury-containing compounds, is cooled by any means known to those in the art, preferably by heat exchanger or water evaporation, to a temperature at or below 250° C. Flyash contained in the gas stream may be sufficient to act as filter aid. If insufficient flyash is present in the gas stream, supplemental flyash may be added in the process contacting step to improve separation in the filtering step.

The gas stream is contacted with treating agents in a mixer or other form of a mixing vessel. The treating agents may undergo combustion prior to introduction into a mixing vessel and the combustion vapors from the treating agents may be introduced into the gas stream in the mixing vessel. Combustion vapor from treating agents can be introduced by any means known to those in the art, preferably via spray nozzles to a mixing vessel. Alternatively, in the case of evaporative cooling, the vitrifying agent may be applied in the cooling water that is injected into the hot gas stream to cool the stream to a temperature at or below 250° C. Upon contact with the gas stream, the treating agents condense on the flyash and react with mercury to form a filterable stream.

By filterable stream, it is meant that the gas stream is capable of passing through a porous medium, where a solid portion of the stream is retained on the porous medium. The remaining gas stream—after the filtering step, which is a cleaned gas, meets environmental emission standards for mercury. If this stream meets all environmental emission standards, the stream may be vented to a stack for release. If the stream does not meet all environmental emission standards, the stream may be further processed. By further processed includes using the process of this invention to prepare a gas stream for other treatments. For example, the remaining gas stream may comprise SOₓ and NOₓ, and thus be subject to additional treatments, such as wet scrubbing to remove SOₓ followed by ozone treatment to treat NOₓ.

Filtering of the stream can be accomplished by any means known to those in the art for filtration of gases. The resulting filtered solids comprise flyash, mercury-containing compounds and other filterable and non-filterable compounds adsorbed on flyash or other solid component. The filtered solids tend to be agglomerated, allowing the use of common filtration devices. Examples of such devices include, but are not limited to, electrostatic precipitators, fabric filters, and sintered ceramic or metal filters.

The percent of filterable solids in the incoming flue gas stream is typically less than 6% by weight of the fuel burned.

### Filtered Solid Product

The filtered solid from the present invention is a solid comprising fly ash and reaction products of a vitrifying compound mercury and titanium and/or zirconium. The product has low mercury leachability and no added carbon content.

The filtered solid comprises mercury and has low leachability of mercury when subjected to acids, such as acetic acid and sulfuric acid. Mercury content in the solid product can not be quantified using standard mercury analytical techniques due to residual vitrifying compounds. However, mercury leachability in the product produced in this invention is less than 0.025 mg/L as determined by analysis per RCRA TCLP (toxic characteristic leachate procedure) on the filtered solids. This low leachability property permits uses not previously considered due to mercury contamination concerns. Filtered flyash containing mercury was previously disposed of in a secure landfill.

The filtered solid further comprises components from the vitrifying compound and optionally titanium or zirconium complex. Preferably the vitrifying agent is boric acid, phosphoric acid, methyl borate, or a combination of two or more thereof. Thus, a preferred filtered solid comprises boron, phosphorus, or a combination thereof. The filtered solid generally comprises about 2 to about 12 moles of boron, phosphorus or a combination thereof per mole of mercury, preferably about 3 to about 6 moles of boron, phosphorus or a combination thereof per mole of mercury. More preferably, the filtered solid comprises about 3 to about 6 moles of boron per mole of mercury.

When titanium or zirconium complex is added as a treating agent, the filtered solid further comprises from about 0.1 to about 1 mole of titanium, zirconium, or a combination based on the number of moles of vitrifying compound used in the process to produce the filtered solid. Preferably, the vitrifying agent comprises boron, phosphorus, or a combination thereof. Thus, preferably, the filtered solid comprises from about 0.1 to about 1 mole of titanium, zirconium, or a combination thereof based on the total number of moles of boron and phosphorus. More preferably, the filtered solid comprises from about 0.3 to about 0.5 mole of titanium, zirconium, or a combination thereof based on the total number of moles of boron and phosphorus. Still, more preferably, the filtered solid comprises about 0.3 to about 0.5 moles of titanium per mole of boron.

The filtered solid of this invention has low leachability which enables it to be used in various end uses. Using the treating agents in this invention allows the filtered solid to contain less carbon than when mercury-containing gases are treated with carbon adsorbents. Applications adding activated carbon and lime-coated carbon comprise higher carbon residuals in the flyash than the solid product of this invention. The filtered solid of the present invention contains no added carbon and can be used in applications where high carbon content is undesirable, such as flyash concrete.

The present invention provides a concrete comprising the filtered solid product of this invention. The filtered solid meets ASTM C618 specifications for Type F or C fly ash for use in concrete. The inventive flyash concrete has many advantages compared to conventional Portland cement concrete. For example, the spherical shape of flyash improves lubricity relative to Portland cement concrete, which allows for easier pumping of flyash concrete. In addition, flyash concrete of this invention uses less water and provides stronger concrete per unit weight of concrete.

The process of the present invention produces a filtered product that has a number of advantages over product produced using carbon for mercury removal from gas streams. Product produced using carbon can adsorb many of the wetting agents used in concrete production requiring an increase in wetting agents. In fact, carbon-based processes for mercury removal from gas streams may have such high carbon contents that they may be unsuitable for use in concrete.

In the present invention, the filtered solid has lower carbon content which allows for use of less wetting agents when producing and moving concrete, and further increases concrete strength. Flyash concrete according to this invention can be mixed with air to lower density of the concrete. The increased concrete strength along with lower density allows the flyash concrete produced according to this invention to be used in applications where lightweight concrete is desirable, such as a fire barrier in steel frame buildings and in bridge decks.

### DETAILED DESCRIPTION OF DRAWING

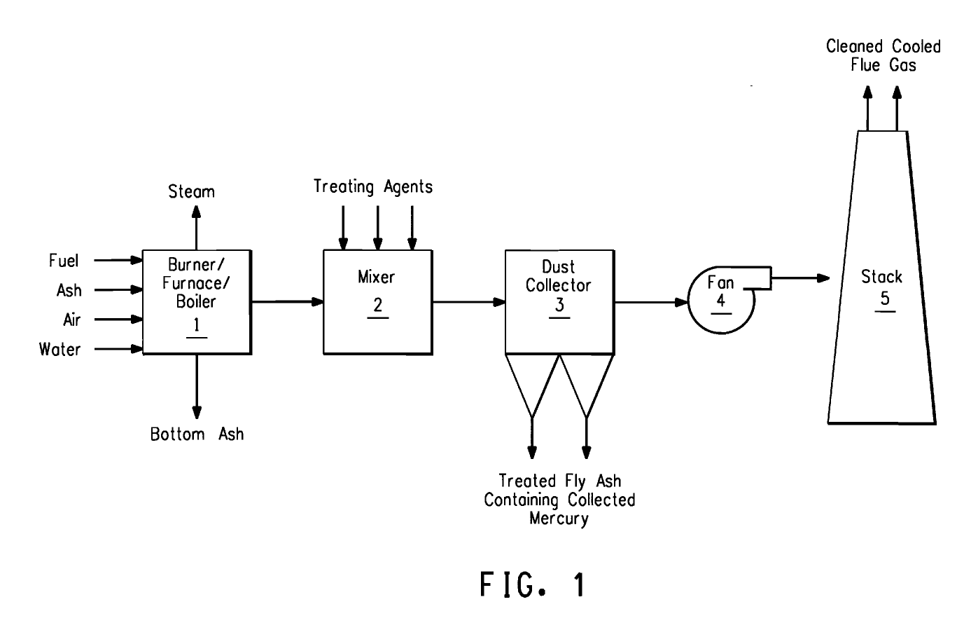

FIG. 1 is a diagram of a simple burner system. In general, a fuel is burned in burner/furnace/boiler 1 with excess air, usually in the presence of at least some ash and some water. Coal-containing ash, for instance, may be burned along with steam-atomized residual oil. Thus, the source of flyash in the gas stream or process may be natural ash as a component of the fuel, e.g., coal.

Alternatively, process wastewater or sludge may be burned along with natural gas or atomized fuel oil. There is typically a furnace chamber with a residence time of a few seconds in which any solid carbon in char residues can complete burnout. Ash is produced in such a furnace chamber (not shown) and fed to burner/furnace/boiler 1. Coarser ash will settle out and be removed as bottom ash; finer ash will blow over to be removed later as fly ash. When the hot fly ash is not sticky, hot gas will usually exit through a boiler for making useful steam. When the hot fly ash is sticky, hot gas will usually be cooled by evaporation of water sprayed and mixed in mixer 2 directly into the flue gas in a uniform way. If there is insufficient natural flyash present in the fuel to achieve effective filtration downstream, supplemental ash can be added at mixer 2.

Flue gas, which comprises finer ash (fly ash), produced from burner/furnace/boiler 1 is transferred to mixer 2. Treating agents are contacted with flue gas in mixer 2. Treating agents may be sprayed with or without water directly into the flue gas in a uniform way. It is frequently preferred to spray/mix different treating agents in a particular sequence in order to get the best effect from reactions. For instance, U.S. Pat. No. 4,600,568 teaches that injection of dry powdered hydrated lime followed later by coarse dampening sprays of water comprising small amounts of sodium hydroxide results in notably high absorption of sulfur dioxide. Such “dry scrubbing” is described in Perry's Chemical Engineers' Handbook, 8^{th} Edition, pages 17-43 through 17-45. It is generally found that reaction immediately after mixing volatile mercury compounds and treating agents in mixer 2 is limited by mass transfer of mercury from the gas stream to the active scavenging surface (flyash particles) for flyash particles in flight, which can be on the order of millimeters apart. Thus, the majority of removal of mercury takes place in the subsequent fabric filter (dust collector) 3 where the flyash particles may be only micrometers apart and mass transfer is much faster.

This process may be used at higher dosages of vitrifying compounds with an electrostatic precipitator when the untreated ash resistivity is sufficiently low.

The reactions which occur in mixer 2 and fabric filter (dust collector) 3 to convert volatile mercury compounds into non-volatile mercury compounds fundamentally differ from those in conventional lime or carbon injection dry scrubbing, both of which are used commercially for mercury control. The overall effect is that volatile mercury in the flue gas reacts with the added treating agents and flyash to produce a treated flyash containing mercury in a nonvolatile nonleachable form. Thus the flyash can be used in the normal proportions in mixtures with Portland cement to make the usual high-strength and lightweight flyash concretes.

Treated flue gas is drawn through dust collector 3 by a fan 4, and discharged through a stack 5. The temperature of the treated flue gas is not close to the water vapor dewpoint, so there are no unusual corrosion challenges.

### EXAMPLES

### Comparative Example A

Empty drums from shipping organic compounds containing mercury are decontaminated by thermal treatment in a car-bottom furnace having multiple small primary low-excess-air fuel-oil-fired burners mounted in the freeboard so as to evaporate organics and mercury. Additionally, a large secondary high-excess-air multifuel-fired burner burns up evaporated volatile organics from the furnace exhaust. Fuel for the secondary burner is low-sulfur fuel-oil including decanted wet spent solvents from the process to manufacture the organic compounds. The solvents contain chlorine compounds (chlorine source). When solvents containing relatively more mercury are in use, the uncontrolled concentration of mercury in the flue gas can be up to many times higher when compared to mercury concentrations from coal combustion.

After the secondary burner there is about 1 second of retention time in a mixing chamber, similar to that reported in U.S. Pat. No. 3,861,330. The sulfur/halogen ratio is low and there is little flyash produced. Flue gases are cooled by evaporation of air-atomized potable water injected at such a rate as to control inlet temperature to a following glass fiber baghouse between 190° C. and 230° C. Two seconds of retention time is provided after the water sprays which assures complete water evaporation. The warm flue gas contains volatile mercury, which is not treated.

### Example 1

The process of Comparative Example A is repeated with mercury control. Boric acid and TYZOR TBT organic titanate (available from E. I. du Pont de Nemours and Company, Wilmington, Del.) are dissolved in methanol and burned along with process solvents in the secondary burner. Clean low-sulfur coal flyash is added to a mixer to build a pre-coat about 1 mm thick on a fabric filter. The decontamination furnace is a one-day-cycle batch process, thus, it is not necessary to feed flyash except as a precoat at the beginning of each operating day. Residual boric acid in the collected flyash prevents leaching or volatilization of mercury.

### Comparative Example B

Wastewater from the disposal of acidic process catalyst residues containing chlorine source is made just slightly alkaline with hydrated lime slurry. The resulting metal-rich solids, along with a slight excess amount of lime, are treated with a flocculant and are allowed to settle. Settled solids are dewatered on a belt press to a filtercake of about 20% solids, which is then fed into a fuel-oil-fired two-stage fluidized bed calciner to convert the metals into a nonleachable state for landfill. A bed of fluidized olivine is run air-starved, burning fairly high-sulfur fuel-oil with a combustion retention time of about 1 second. Secondary air is introduced just above the fluidized bed so that the freeboard runs with about 30% excess air, and with a combustion retention time of about 3 seconds at 900° C. Sulfur/halogen ratio is fairly high, where sulfur and halogen originate in the wastewater (chlorine source). Because there is a slight net excess of lime, there is little offgas SO₂, and the flyash is slightly alkaline. About half the total ash is removed as bed purge, and the other half carries over as flyash. Hot flue gas containing abundant flyash is cooled by evaporation of coarsely-air-atomized potable water (evaporative cooling water) injected at such a rate as to control inlet temperature to a PTFE fabric filter between 180° C. and 200° C. Four seconds of retention time is sufficient to remove water from the flyash. The water predominately collides with suspended flyash and dries from the flyash surface.

### Example 2

The process of Comparative Example B is repeated with mercury control. Since there is plenty of flyash of slightly alkaline quality, it is only necessary to provide a scavenging coat of boric acid. This is done by adding boric acid to the evaporative cooling water at a ratio of at least 6 moles boron per mole of mercury. This results in more than 90% mercury containment without significant effect on fabric filter pressure drop. Mercury leachability is less than 0.025 mg/L as per RCRA TCLP (toxic characteristic leachate procedure) on the filtered solids.

### Comparative Example C

Low-sulfur western subbituminous coal of low oxide factor is burned at moderate excess air in an industrial spreader-stoker boiler equipped with mechanical collectors and fabric filters, producing a flue gas. Flue gas comprises an oxygen-containing gas, chlorine source and water. Flue gas temperature going into the fiberglass fabric filters is controlled between 180 and 200° C. using hot gas bypass around the combustion air preheater.

### Example 3

The process of Comparative Example C is repeated with mercury control. Since there is a reasonable amount of flyash of slightly alkaline character and chlorine present from the coal, it is only necessary to provide a scavenging coat of boric acid. That is done by aspirating a strong aqueous solution of boric acid with a steam-jet venturi, then distributing the dilute boric acid vapor in steam through a grid arranged in the ductwork so as to provide good mixing with the main flue gas stream for about 3 seconds prior to entering the fabric filters. This results in more than 90% mercury containment relative to Comparative Example C without significant effect on fabric filter pressure drop.

### Comparative Example D

Medium-sulfur eastern subbituminous coal of high oxide factor is burned at moderate excess air in an industrial pulverized-coal boiler equipped with mechanical collectors and two-field electrostatic precipitators of moderate specific collector area. Flue gas temperature going into the electrostatic precipitators varies with firing rate, but is usually between 170 and 210° C.

### Example 4

The process of Comparative Example D is repeated with mercury control. A legacy system is designed for high oxide-factor high-sulfur coal, and uses selected high-oxide-factor medium-sulfur coal so as to allow higher operating voltages in order to achieve its particulate control limits. The product of coal burning contains a chlorine source for the process, water and oxygen for the process. The ash from such coal is coated with a monolayer of sulfuric acid. To provide a scavenging coat of boric acid for mercury, it is necessary to provide an excess of alkaline TiO₂ to neutralize the strong surface acidity on the flyash so that weak boric acid can precipitate on it. In a small burner offline, a solution of boric acid and TYZOR TPT organic titanate (available from E. I. du Pont de Nemours and Company, as a solution in isopropanol), is burned. The combustion flue gases comprising boric acid vapor and titanium borate solids mixes with heated carrier air which distributes the dilute boric acid vapor and titanium borate solids through a grid arranged in the ductwork and provides good mixing with the main flue gas stream for about 3 seconds prior to entering the electrostatic precipitators. This results in more than 90% mercury containment without significant effect on electrostatic precipitator sparking threshold or dust removal by rapping.

Note that there are some coals of marginal oxide factor which normally generate ash of relatively high resistivity; treating of those coals with this process can depress the sparking threshold voltage and force a firing rate reduction in order to stay within particulate limits. This may be compensated for by using medium-pressure steam as treating agent carrier gas if available.

What is claimed is:

1. A process to remove volatile mercury from a gas stream, which stream comprises volatile mercury compounds, comprising contacting the stream with
(a) a vitrifying compound,
(b) water,
(c) oxygen-containing gas, and
(d) a chlorine source,
to provide a filterable stream; and filtering the stream to obtain a solid product comprising mercury.

2. A process according to claim 1 further comprising contacting the stream with an organic titanium complex or an organic zirconium complex.

3. A process according to claim 1 wherein the gas stream is a flue gas generated from the combustion of coal, oil, natural gas, or combinations thereof.

4. A process according to claim 1 wherein the gas stream is an exhaust gas stream produced during the thermal treatment of mercurial wastes from hospitals, wastewater treatment, municipal solid waste concentrates, scrap-melting steel mill equipment, or secondary metal smelter off gas.

5. A process according to claim 1 wherein the vitrifying compound is boric acid, phosphoric acid, methyl borate, or a combination of two or more thereof.

6. A process according to claim 5 wherein the vitrifying compound is boric acid.

7. A process according to claim 1 wherein the vitrifying compound is added at a concentration of from about 2 to about 12 moles of vitrifying compound per mole of mercury.

8. A process according to claim 1 wherein the vitrifying compound is added at a concentration of from about 3 to about 6 moles of vitrifying compound per mole of mercury.

9. A process according to claim 1 wherein the oxygen-containing gas is molecular oxygen (pure oxygen), air, or oxygen-depleted combustion flue gas.

10. A process according to claim 1 wherein the oxygen-containing gas a combustion gas stream comprising oxygen.

11. A process according to claim 1 wherein the chlorine source is sodium chloride, hydrochloric acid, trichloroethylene, dichloromethane, dichlorobenzene, or combinations thereof.

12. A process according to claim 11 wherein the chlorine source is added in an amount capable of generating at least 10 moles of HCl per mole of mercury.

13. A process according to claim 2 wherein the organic titanium complex or organic zirconium complex is selected from the group consisting of zirconium acetate, zirconium propionate, zirconium butyrate, zirconium hexanoate, zirconium 2-ethyl hexanoate, zirconium octoate, tetraethyl zirconate, tetra-n-propyl zirconate, tetraisopropyl zirconate, tetrabutyl zirconate, titanium acetate, titanium propionate, titanium butyrate, titanium hexanoate, titanium 2-ethyl hexanoate, titanium octoate, tetraethyl titanate, tetra-n-propyl titanate, tetraisopropyl titanate, tetrabutyl titanate, and combinations of two or more thereof.

14. A process according to claim 13 where the organic titanium complex or organic zirconium complex is selected from the group consisting of tetraethyl titanate, tetra-n-propyl titanate, tetraisopropyl titanate, tetrabutyl titanate, and combinations of two or more thereof.

15. A process according to claim 1 wherein the stream is filtered using an electrostatic precipitator, fabric filter, sintered ceramic filter or metal filter.

16. A solid composition comprising flyash, mercury, and boron, phosphorus, or a combination thereof, wherein mercury leachability in the composition is less than 0.025 mg/L as per RCRA TCLP (toxic characteristic leachate procedure).

17. A composition according to claim 16 comprising about 2 to about 12 moles of boron, phosphorus or a combination thereof per mole of mercury.

18. A composition according to claim 17 comprising about 3 to about 6 moles of boron, phosphorus or a combination thereof per mole of mercury.

19. A composition according to claim 17 comprising about 3 to about 6 moles of boron per mole of mercury.

20. A composition according to claim 16 further comprising titanium, zirconium or a combination thereof.

21. A composition according to claim 20 comprising from about 0.1 to about 1 mole of titanium, zirconium, or a combination thereof based on the total number of moles of boron and phosphorus.

22. A composition according to claim 21 comprising from about 0.3 to about 0.5 mole of titanium, zirconium, or a combination thereof based on the total number of moles of boron and phosphorus.

23. A composition according to claim 22 comprising about 0.3 to about 0.5 moles of titanium per mole of boron.

24. A concrete comprising the composition of claim 16.
